(19) United States
(12) Patent Application Publication
(10) Pub. No.: US 2003/0131002 A1
(43) Pub. Date: Jul. 10, 2003

(54) Method and apparatus for identifying a digital image and for accessing the digital image over a network

(76) Inventors: K. Douglas Gennetten, Fort Collins, CO (US); Andrew C. Goris, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/041,207

(22) Filed: Jan. 8, 2002

(51) Int. Cl. G06F 15/16; G06F 17/30; G06F 7/00

(52) U.S. Cl. 707/10; 709/217

(57) ABSTRACT

A method according to one embodiment of the present invention is disclosed that comprises the steps of acquiring a digital image, and automatically assigning an identifier to the digital image. The identifier allows the digital image to be accessed over a network.

### FIELD OF THE INVENTION

This invention relates generally to digital images and more specifically to a method and apparatus for identifying a digital image and for accessing the digital image over a network.

### BACKGROUND

The Internet has developed into a widely used medium for communicating and sharing information and visual images with others. Indeed, relatively inexpensive digital image capture devices, such as digital cameras and scanners, have made it increasingly more convenient to share images via the Internet. For example, new parents may share a digital photograph or image of their newborn baby with friends and relatives by first attaching the digital photograph to an email and then sending the email with the digital image attachment to those friends and relatives. Upon receipt of the email, the recipient(s) may then view the digital image of the newborn baby. Alternatively, the new parents may post the digital image to an Internet web page thereby allowing family and friends to view the photo by visiting that Internet web page.

Although the ease in which digital images may be shared over the Internet has undoubtedly led to the increasing popularity of digital image capture devices, the sharing of digital images via the Internet is not without its problems. For example, depending on the resolution of a digital image and the type of file in which it is stored, the file size of the digital image may be very large. Such large files can be problematic when sent to certain email accounts since many email service providers limit the size of the email accounts they provide (e.g., hotmail accounts are limited to 2 megabytes, etc.). Consequently, an email having one or more digital images attached thereto may exceed the account size limitation(s) of the email account(s) to which it is sent. Depending on the particular email service provider being used, the recipient's email account may be shut down (i.e., “crash”) and become inoperable if the email account size limitation is exceeded.

The file size associated with digital images may also necessitate the expenditure of considerable time and processing capacity to share digital images via the Internet. For example, to share digital images via email, a user must first attach the digital images to an email before sending the email. To share digital images via an Internet web page, a user must first post or upload the digital images to be shared to the Internet web page. The process of attaching a digital image to an email and uploading a digital image to an Internet web page can both be time consuming. Moreover, neither approach allows a user to share a digital image relatively immediately after it was captured with a digital image capture device.

Another method of sharing digital images via the Internet is to upload digital images to a “digital photo album” maintained by one of the various Internet services that allow users to store and manage (e.g., view, edit, share, etc.) their digital images in digital photo albums. Each Internet service provider usually provides its own unique proprietary twist on its digital photo albums including, but not limited to, how its digital photo albums may be accessed, what its digital photo albums may contain, how the digital images within its digital photo albums may be shared, etc. Due to the lack of uniformity, however, the functionality of such digital photo albums is greatly curtailed. For example, before a user may ultimately gain access to a digital image contained within a digital photo album, the user may first have to expend considerable time and effort to gain the requisite familiarity with the features (e.g., view, print, edit, etc.) of the digital photo album in which the digital image is stored.

### SUMMARY OF THE INVENTION

A method according to one embodiment of the present invention is disclosed that comprises the steps of acquiring a digital image, and automatically assigning an identifier to the digital image. The identifier allows the digital image to be accessed over a network.

### BRIEF DESCRIPTION OF THE DRAWING

Illustrative embodiments of the invention are shown in the accompanying drawing in which:

FIG. 1 is a high level diagram illustrating the components of an embodiment of a system for identifying a digital image and for accessing the digital image over a network;

FIG. 2 is a flow chart illustrating an embodiment of a method that may be used in the system shown in FIG. 1 for identifying a digital image and for accessing the digital image over a network; and

FIG. 3 is a high level diagram illustrating the components of a second embodiment of a system for identifying a digital image and for accessing the digital image over a network.

### DETAILED DESCRIPTION OF THE INVENTION

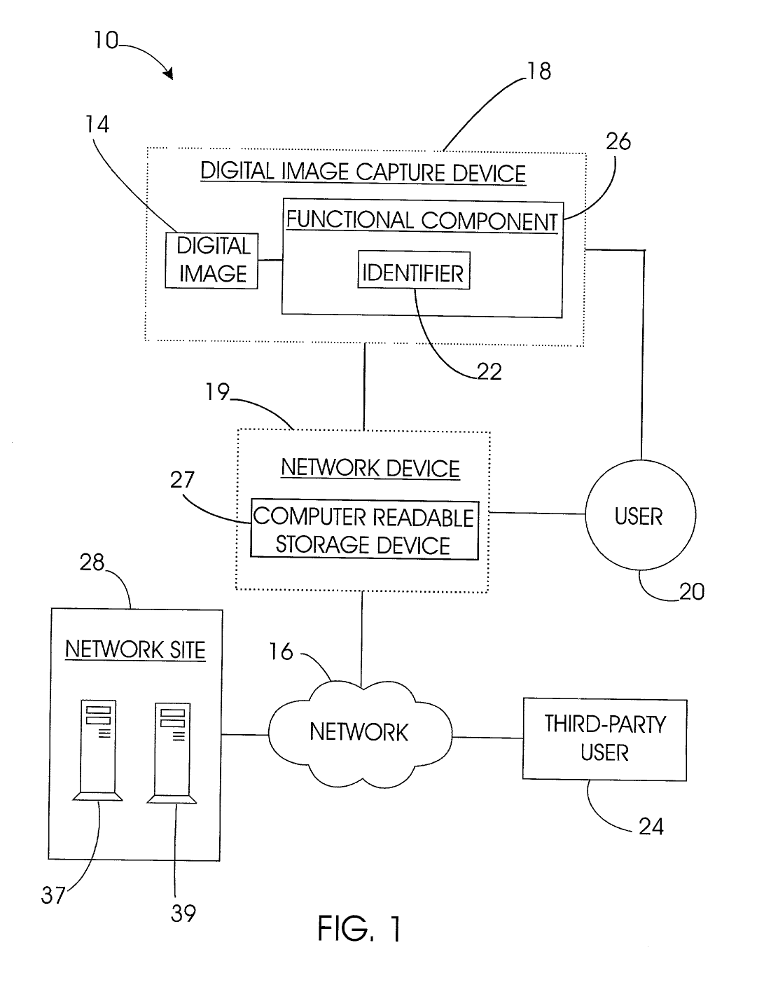

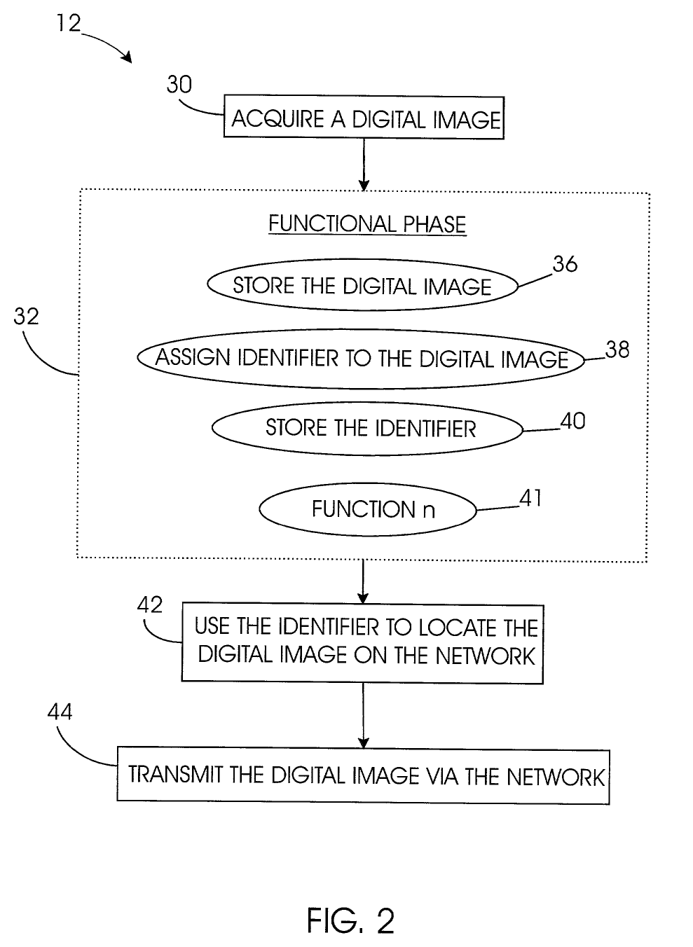

An apparatus 10 and a method 12 is shown and described herein as it could be used for identifying a digital image 14 and for accessing (e.g., archiving, storing, identifying, editing, sharing, tracking, etc.) the digital image 14 over a network 16. The apparatus 10 is shown in FIG. 1, whereas the method 12 is illustrated in FIG. 2. Briefly, the present invention generally comprises acquiring the digital image 14 and then automatically assigning an identifier 22 to the digital image 14 so that the digital image 14 may be accessed over the network 16.

One advantage that may be realized by an embodiment of the invention is that a user 20 may share the digital image 14 with others (e.g., third-party user 24, etc.) relatively immediately after the digital image 14 is acquired, for example, by a digital image capture device 18 (e.g., digital camera, scanner, etc.). More specifically, a functional component 26 of apparatus 10 may assign the identifier 22 to the digital image 14 relatively immediately after it was captured by the digital image capture device 18. To share the digital image 14 then, the user 20 may simply share the identifier 22 (e.g., URI, URL, etc.) with the third-party user 24 who may then, assuming that the device upon which the digital image 14 is stored is linked to the network 16, use the identifier 22 to access the digital image 14. Indeed, the identifier 22 allows the digital image 14 to be shared with or be accessed by the third-party user 24 over the network 16 even though the user 20 has not undergone the timely process of uploading or transferring the digital image 14 from the device (e.g., network device 19, digital image capture device 18, etc.) in which the digital image 14 was stored to, for example, an Internet web page, digital photo album, or an email. For example, an Internet film developer may use the identifier 22 and obtain the digital image 14 (e.g., to develop and print the digital image 14, etc.) over the network 16 directly from the device in which the digital image 14 was stored thereby obviating the need for the user 20 to upload the digital image 14 to the Internet film developer's web site.

Moreover, if the manner in which the identifiers are to be assigned is known (i.e., if the user 20 knows beforehand what identifiers will be assigned to the user's 20 digital images), the user 20 may provide such identifiers to the third-party user 24 before the digital images are even acquired. In doing so, the third-party user 24 may then be allowed to view in “real-time” the digital images assigned the identifiers assuming that the device upon which the digital images are maintained is linked to the network 16. For example, the third-party user 24 may be able to view each evening the digital images acquired that day by the user 20.

Another advantage that may be realized by an embodiment of the invention is that any server linked to the network 16, such as a Web server, should be able to “host” (e.g., find, retrieve, display, etc.) the digital image 14. In other words, the digital image 14 may be accessed over the network 16 from various locations and at various times by making the appropriate request with a network device linked to the network 16. In addition, a user's digital image collection may be referenced by or linked from a computer readable file, such as a simple text file based on a markup language such as HTML, XML or SGML, by storing the various identifies assigned to the user's digital images in a computer readable file. The computer readable file and the identifiers stored therein, which may then be shared with others, provides an easy way for a user to share his or her digital image collection. Since the computer readable file stores the identifiers and not the digital images themselves, the computer readable file should be relatively small and be more manageable than would be a file containing the digital images themselves.

Yet another advantage that may be realized by an embodiment of the invention is that assigning identifiers to each digital image residing on the network 16 may allow each of those digital images to be accessed independently and separately from the other digital images residing on the network 16. For example, a user may access the digital image 14 individually over the network 16 without having to access the other digital images captured by the same digital image capture device 18 and assigned identifiers by the functional component 26.

The assignment of identifiers to digital images may also allow for the tracking of the digital images. For example, a record may be maintained containing access information relating to the digital image 14 such as information on the number of times the digital image 14 has been accessed (e.g., viewed, copied, printed, etc.), on the identities of the users who have accessed the digital image 14, on the changes made to the digital image 14, etc. By accessing the record, the user 20 may be able to determine, for example, whether a particular individual has viewed the digital image 14, among other things.

Still yet another advantage that may be realized by an embodiment of the invention is that using Internet Protocol version 6 (“IPv6”) to assign a uniform resource identifier (“URI”) to a digital image may allow the IPv6 URI assigned to the digital image to be unique and permanent. For example, in one embodiment, the URI may be preserved for the life or existence of that digital image. That is, the IPv6 URI originally assigned to a digital image should not change or be assigned to any other digital images while that digital image exists. Indeed, with the costs associated with data storage continuing to decrease, the digital image and the URI assigned thereto may even be preserved in perpetuity. In any event, by providing each digital image with a permanent-by-photo IPv6 URI, organization and sharing of the digital images may become simply a matter of a markup language such as HTML, XML, or SGML.

In addition, an embodiment of the present invention may also allow for the realization of proprietary or monetary gains. For example, a commercially operated service may store a user's digital images for a fee.

A further advantage that may be realized by an embodiment of the invention is that it may allow for the digital images to be referenced in an object-oriented manner over a network. That is, the digital images may be treated as objects instead of being treated as just data thereby allowing for the support of “methods” which may be used in conjunction with the digital image 14 (e.g., resizing the digital image 14, printing the digital image 14, rotating the digital image 14, etc.) and for the support of “properties” of the digital image 14 (e.g., file size, capture date, last access, etc.). For example, computer readable program code may be provided that allows a user to specify a format (e.g., black and white, low resolution, high resolution, original version, thumbnail view, latest version, etc.) for the digital image 14 and that formats the digital image 14 to the specified format so that the digital image 14 will ultimately be provided to the user in that specified format.

Having briefly described the apparatus 10 and method 12 according to one embodiment of the invention, as well as some of their more significant features and advantages, various embodiments of the apparatus 10 and method 12 will now be described in further detail.

FIG. 1 is a high level diagram illustrating the components of one embodiment of the apparatus 10 that may be used for identifying the digital image 14 and for accessing (e.g., archiving, storing, identifying, editing, sharing, tracking, etc.) the digital image 14 over the network 16. It is understood that although the invention is preferably for use with the Internet, the invention is not limited strictly for use with the Internet. That is, although the network 16 is preferably a Transmission Control Protocol/Internet Protocol (TCP/IP) network, the network 16 may be any suitable network or networks, including but not limited to, a local area network (LAN), a wide area network (WAN), a secure network, an Intranet, the Internet, a combination thereof, etc.

The apparatus 10 may comprise the digital image capture device 18 that may be used by the user 20 to capture the digital image 14. The digital image capture device 18 may comprise any of a wide range of digital image capture devices now known in the art or that may be developed in the future. For example, the digital image capture device 18 may comprise a digital camera or a scanner.

In the embodiment shown and described herein, the digital image capture device 18 is operatively associated with or linked to the network 16 by way of a network device 19. The network device 19 may comprise any of a wide range of systems capable of linking to the network 16 that are now known in the art or that may be developed in the future, such as a personal computer, a network server, a kiosk, a handheld device, an Internet site, a dedicated e-enabled appliance, a webTV or Internet television, a web terminal, an Internet appliance (i.e., a device dedicated to email, Internet access, and possibly other limited functions), etc. The network device 19 may be operatively associated with or linked to the network 16 via any suitable means (e.g., modem, T-1, T-3, cable, digital subscriber line (DSL), infrared, BLUETOOTH™, etc.), through yet other devices (e.g., routers, hubs, etc.), other networks (e.g., LAN, WAN, Intranet, etc.), through a combination of networks, etc.

It should be noted, however, that the digital image capture device 18 need not be linked to the network 16 by the network device 19. Instead, the digital image capture device 18 may be directly linked to the network 16 (i.e., with no intermediary devices between the digital image capture device 18 and the network 16, not shown) or may be linked to the network 16 via one or more intermediary devices, such as a personal computer. Indeed, the digital image capture device 18 may be linked to the network 16 via any other suitable means, including but not limited to, a hardwired connection, an infrared connection, a dial-up connection (i.e., using a modem), a dedicated connection (e.g., cable, digital subscriber line (DSL), T-1, T3), via BLUETOOTH™, via satellite, through yet other devices (e.g., routers, hubs, etc.), through other networks (e.g., LAN, WAN, Intranet, the Internet, etc.), through a combination of networks, etc.

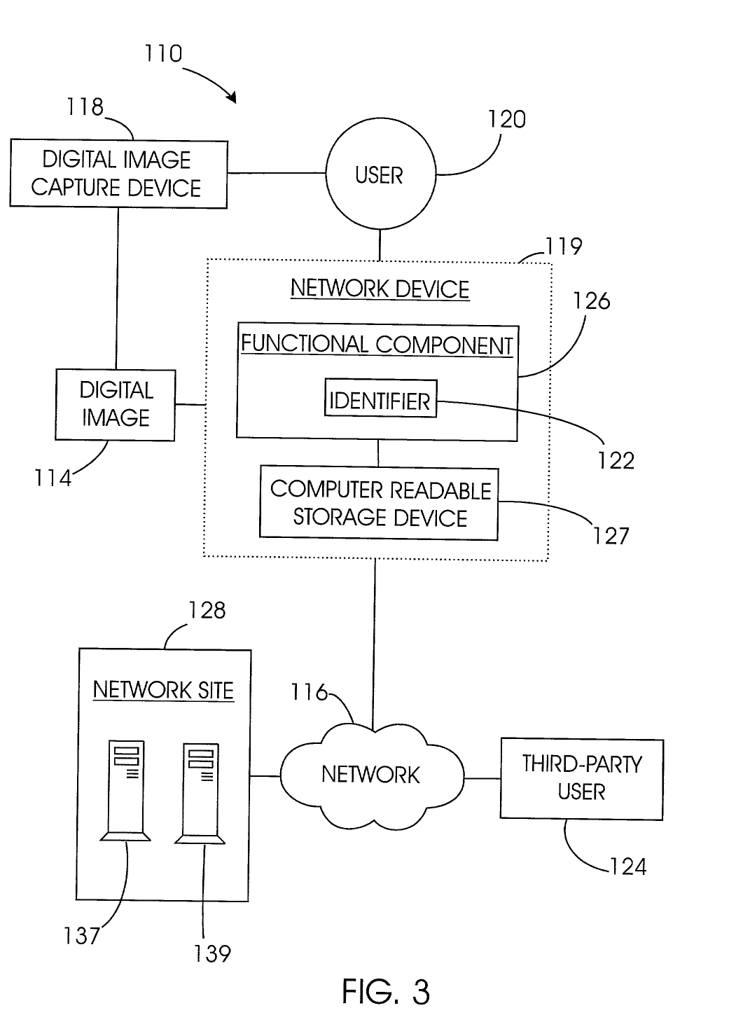

In an alternative embodiment 110 (FIG. 3) that is described in greater detail below, the digital image capture device 118 need not ever be linked to the network 116. Instead, the digital image 114 may be downloaded or transferred from the digital image capture device 118 to the network device 119 (e.g., personal computer, etc.) that may or may not be linked to the network 116 at the time the digital image 114 was acquired and/or was transferred to the network device 119. For the digital image 114 to be accessed over the network 116, however, the network device 119 to which the digital image 1 14 is transferred must be linked to the network 116. Similarly, if the digital image 14 is not transferred but remains stored on the digital image capture device 18, the digital image capture device 18 must be linked to the network 16 for the digital image 14 to be accessed over the network 16. See FIG. 1.

For carrying out the various functional aspects of the invention, the apparatus 10 may further comprise the functional component 26. It is understood that the functional component 26 may be any suitable hardware and/or software application for performing the respective functions. In one embodiment, the functional component 26 may comprise computer readable program code and the necessary hardware (e.g., an Intel PENTIUM® Processor, etc.) for executing the same. Such computer readable program code may comprise program code for assigning unique identifiers to digital images so that each respective digital image may be accessed over the network 16 separate and apart from the other digital images assigned identifiers. For example, the identifier 22 assigned to the digital image 14 may be used in conjunction with a web browser to access the digital image 14 over the network 16.

The computer readable program code that may comprise the functional component 26 may be stored in one or more computer readable storage media residing at, or associated with, the digital image capture device 18. Alternatively, the computer readable program code comprising the functional component may be stored in one or more computer readable storage media residing at, or associated with, the network device 119 (FIG. 3), the primary server 37, the secondary server 39, elsewhere on the network 16 (e.g., at another server, etc.) or in some combination thereof. Regardless of where it resides, however, the computer readable program code may comprise program code for carrying out one or more of the various steps of the method 12 shown in FIG. 2.

In the embodiment shown and described herein, the functional component 26 may assign the identifier 22 to the digital image 14 automatically (i.e., without any user intervention) almost immediately after the digital image 14 is captured or acquired by the digital image capture device 18. In the alternative embodiment 110 (FIG. 3) that will be described in greater detail below, the functional component 126 may reside within the network device 119 such that the identifier 122 is not assigned until after the digital image 114 has been transferred or downloaded to the network device 119, for example, from the digital image capture device 118. In yet another alternative embodiment (not shown), the functional component may reside elsewhere on the network 16, and the identifier 22 may not be assigned to the digital image 14 until after the digital image 14 has been transmitted over the network 16 to the network location(s) at which the functional component resides.

The identifier 22 that is assigned to the digital image 14 may comprise a permanent (i.e., non-dynamic) unique identifier, such as a uniform resource identifier (“URI”), uniform resource locator (“URL”), etc. The URI assigned to the digital image 14 may be globally unique and permanent such that the URI specifically identifies only the digital image 14 on the network 16, and the URI remains fixed (i.e., is not changed). Stated differently, the identifier 22 assigned to the digital image 14 is preferably unique throughout the world such that no other digital image, device, file, etc. has the same identifier as the identifier 22 during the life of the digital image 14. In addition, the identifier 22 remains fixed and will not change during the life of the digital image 14. Indeed, the unique identifier 22 may be assigned to the digital image 14 in perpetuity and may never be assigned to another digital image, device, file, etc.

For example, in one embodiment, the identifier 22 may comprise a URL that may be used by a web browser to locate the resource associated with that URL and thus retrieve the digital image 14. More specifically, the URL may specify the protocol (e.g., http, ftp, etc.) to be used in accessing the digital image 14, the name of the server or other device on which the digital image 14 resides, and the path to the digital image 14. Depending on the particular application, a user may type the URL into an address field of a web browser; the URL may be displayed as a hyperlink that the user may activate by clicking; etc. In any event, the URL or other identifier assigned to the digital image 14 allows the digital image 14 to be accessed over the network 16.

To assign the identifiers to the digital images, the functional component 26 may use Internet Protocol version 6 (“IPv6”). Briefly, IPv6 is a proposed next generation protocol for the Internet that has been developed in part to resolve the shortage of available IP addresses associated with the currently being used Internet Protocol version 4 (“IPv4”). With IPv4, a 32-bit (4-byte) binary number is used to uniquely identify a host (e.g., computer, etc.) connected to the Internet to the other Internet hosts, for the purposes of communication through the transfer of packets. The IPv4 addresses are expressed in “dotted quad” format, consisting of the decimal values of its 4 bytes, separated with periods (e.g., 127.0.0.1, etc.). The first 1, 2, or 3 bytes of the IPv4 address identify the network the host is connected to; the remaining bits identify the host itself. The 32 bits of all 4 bytes together can signify almost 2³², or roughly 4 billion, hosts (a few small ranges within that set of numbers are not used). However, with the increasing popularity of the Internet, there is a shortage of available IP addresses with IPv4. Although Dynamic Host Configuration Protocol (“DHCP”) is being used in conjunction with IPv4 to enable networks connected to the Internet to assign a temporary IP address to a host automatically when the host connects to the network and thus allows IP addresses to be re-used, IPv6 will nevertheless likely replace IPv4 in the near future. In contrast to IPv4, IPv6 allows addresses to be represented numerically as six sets of digits instead of four. Consequently, IPv6 increases the address space from 32 to 128 bits and provides for a virtually unlimited (for all intents and purposes) number of networks and systems.

When using IPv6, the functional component 26 may assign identifiers to the digital images comprising full physical IP addresses (i.e., the six sets of digits representative of the address) or name addresses (e.g., www.hp.com, etc.). Alternatively, later versions than IPv6 may also be used and other types of identifiers may also be assigned to the digital images as would be obvious to persons having ordinary skill in the art after having become familiar with the teachings of the present invention.

In addition, the identifiers being assigned to the digital images may be based at least in part on information provided by the user 20. In doing so, the identifiers being assigned to the digital images may be “meaningful” or descriptive of the particular digital images. For example, the user 20 may select a domain name (e.g., “douglas_genneftens_camera1.com”, etc.) and then register that domain name with any of a wide range of domain name registration services. Once registered, the domain name may be temporarily parked or stored on the service's domain name server or registry computer. Eventually, the domain name may be converted to an Internet Protocol address that uniquely identifies the host on which the user's 20 digital images will reside to the other Internet hosts for the purposes of communication. Ultimately, at least a portion of the identifier assigned to each of the user's 20 digital images may comprise the Internet Protocol address. For example, the digital image 14 may be assigned the identifier “douglas_gennettens_camera1.com/digitalimage14”, and subsequent digital images may then be assigned identifiers in sequential order thereafter (e.g., “douglas_gennettens_camera1.com/digitalimage15”; and so on).

In another embodiment, the assignment of the identifiers may be based in part on the digital image capture device 18 being used to capture the digital images. For example, the digital image capture device 18 may be operatively associated with the network 16 and have a permanent physical IP address. If so, the digital images captured with the digital image capture device 18 may be assigned identifiers, at least a portion of which comprises the IP address of the digital image capture device 18.

The IP address, or at least a portion thereof, for the digital image capture device 18 may, for example, comprise the serial number for the digital image capture device 18 or the social security number of the user 20 or purchaser. Or for example, at least a portion of the IP address for the digital image capture device 18 may be based on information provided by the user 20. In one embodiment, the user 20 may select a domain name (e.g., “andy_goris_camera1.com”, etc.) and then register that domain name with any of a wide range of domain name registration services. The selection and registration of the domain name may occur at the time of purchase of the digital image capture device 18 with the purchase price including the fees associated with the registration of the domain name. Once registered, the domain name may be temporarily parked or stored on the service's domain name server or registry computer. Eventually, the domain name may be converted to an Internet Protocol address that uniquely identifies the digital image capture device 18. Ultimately, at least a portion of the identifier assigned to each of the user's 20 digital images may comprise the Internet Protocol address for the digital image capture device 18. For example, the digital image 14 may be assigned the identifier “andy_goris_camera1.com/digitalimage14”, and subsequent digital images may be assigned identifiers in sequential order thereafter (e.g., subsequent digital images may be assigned the identifiers “andy_goris_camera1.com/digitalimage15”; “andy_goris_camera1.com/digitalimage16”; and so on).

As mentioned earlier, the digital images that are assigned identifiers in accordance with the invention may be maintained or stored so that they are accessible over the network 16. In one embodiment, the functional component 26 may further comprise program code for storing the digital images in one or more computer readable media contained within one or more computer readable storage devices linked to the network 16. The digital images may be stored automatically (i.e., without any user intervention), manually, or a combination thereof. Preferably, the one or more computer readable storage devices are always or permanently linked to the network 16. Otherwise, the digital images may be inaccessible to a user when the device(s) upon which the digital images are stored is not linked to the network 16. It should be noted, however, that the identifier 22 may be used to access digital image 14 over the network 16 regardless of where the digital image 14 is ultimately stored or maintained. For example, the identifier 22 may still be used to access the digital image 14 over the network 16 even though the digital image 14 has since been transferred from the network location whereat the digital image 14 was assigned the identifier 22.

In the embodiment shown and described herein, the network or Internet web site 28 may be used to store the digital images. More specifically, the network site 28 may comprise the first or primary server 37 and the secondary or backup server 39. Alternatively, the network site may comprise any number (i.e., one or more) of suitable servers, such as partitioned servers, non-partitioned servers, a combination thereof, etc.

The primary server 37 may comprise a file server on which the digital images, including the digital image 14, may be stored or archived. The primary server 37 may transfer the digital image 14 when a user (e.g., user 20, third-party user 24, etc.) submits an appropriate request for the digital image 14. Alternatively, the digital images may be stored elsewhere on the network site 28, elsewhere on the network 16 (e.g., network device 19, etc.), a combination thereof, etc.

Referring back to FIG. 1, the secondary server 39 may comprise a file server that is used to store backup copies of the digital images. For example, the secondary server 39 may be used to store a backup copy of an original or unedited version of the digital image 14. Alternatively, backup copies of the digital images may be stored elsewhere on the network site 28, elsewhere on the network 16 (e.g., network device 19, etc.), a combination thereof, etc.

It is generally preferred, but not required, that an original or unedited version of each of the digital images be stored in read-only format. Similarly, the backup copies of the digital images may also be stored in read-only format. If the original versions and/or the backup copies of the digital images are stored in read-only format, however, an override feature (e.g., password override, etc.) may be provided that allows a user to access the original versions and/or the backup copies of the digital images and override the read-only format so that the user may make changes thereto.

To conserve storage space, the digital images may be stored for only a limited or a predetermined amount of time. The amount of time that each digital image will be stored may, for example, be designated by the user 20 or may be determined without any user intervention (e.g., preset by programmable code, etc.). By way of example only, in one embodiment, the digital image 14 may be deleted if access to the digital image 14 has not been requested or sought in more than five years. Alternatively, and as mentioned earlier, the digital image 14 could be stored in perpetuity without regard to whether anyone has attempted or gained access to the digital image 14.

In addition to storing or maintaining the digital images, the various identifiers assigned to the digital images may also be stored or maintained. For example, after the functional component 26 assigns the identifier 22 to the digital image 14, the identifier 22 may be stored or placed into a computer readable file, such as a text file based on a markup language such as Hypertext Markup Language (“HTML”), Extensible Markup Language (“XML”), or Standard Generalized Markup Language (“SGML”). The computer readable file may be stored in one or more computer readable media contained within one or more computer readable storage devices linked to the network 16. For example, the computer readable file may be stored within the computer readable storage device 27 of network device 19, within the primary and/or secondary server 37 and/or 39 of network site 28. Alternatively, the computer readable file may be stored elsewhere on the network site 28, elsewhere on the network 16, a combination thereof, etc.

Along with the identifier 22 of digital image 14, the computer readable file may also contain identifiers assigned to other digital images. By storing the identifiers in the computer readable file, the digital images associated with the identifiers may easily be shared by sharing the computer readable file and the identifiers stored therein especially since the computer readable should be relatively small. Indeed, the computer readable file containing the identifiers should be much smaller and more manageable than would a file containing the digital images themselves. It should be noted, however, that the manner in which access is ultimately obtained to the digital images may depend upon how the computer readable file is sent and/or received. For example, the digital images may be displayed on a display apparatus (not shown) as thumbnail images, full-size images, etc., and/or the identifiers may be provided as a series of hyperlinks, etc.

The functional component 26 may also include program code for referencing the digital image 14 over the network 16 in an object-oriented manner or design fashion. In other words, the functional component 26 may be able to treat the digital image 14 as an object instead of just treating the digital image 14 as the data comprising the digital image 14. Such an object-oriented approach may allow for the support of “methods” which may be used in conjunction with the digital image 14 (e.g., resizing the digital image 14, printing the digital image 14, rotating the digital image 14, etc.) and the support of “properties” of the digital image 14 (e.g., file size, capture date, last access, etc.).

In one embodiment, the functional component 26 may comprise program code for specifying a format (e.g., black and white, low resolution, original version, latest version, thumbnail image, file format, etc.) for the digital image 14 and program code for formatting the digital image 14 in that specified format so that the digital image 14 will ultimately be provided to the user in that specified format. For example, the functional component 26 may be able to recognize that an access request to the digital image 14 was made by a printer or Internet film developer, and could thus specify a high resolution format for the digital image 14 and then format the digital image 14 accordingly before the digital image 14 is provided to the printer or Internet film developer making the access request.

The functional component 26 may also comprise program code for allowing a user to specify the format for the digital image 14. For example, a user may be able to specify the format for the digital image 14 by adding an extension (e.g., “.BW” for black and white version, “.HR” for high resolution, “.jpg” for a jpg file format, “.bmp” for a bitmap file format, etc.) to the identifier 22. In one embodiment, the user may enter the identifier 22 and the extension following thereafter into an address field of a web browser. In another embodiment, a user may be able to specify a format for the digital image 14 by making a selection in a pull-down menu in a web browser. Alternatively, other methods for specifying a format are possible as would be obvious to persons having ordinary skill in the art after having become familiar with the teachings of the present invention.

The functional component 26 may further include program code for tracking the digital image 14. For example, a record may be maintained that contains access information relating to the digital image 14 such as information on the number of times the digital image 14 has been accessed, on the identities of the users who have accessed the digital image 14, on the changes made to the digital image 14, etc. By accessing the record, the user 20 may be able to determine, for example, whether a particular individual has viewed the digital image 14, among other things.

It is to be understood that the embodiment shown in FIG. 1 is merely illustrative of an environment in which the invention may be implemented. Other embodiments (e.g., 110, FIG. 3) are also contemplated as being within the scope of the invention. For example, the functional component 26 may reside elsewhere and/or may be subdivided into separate modules, routines and/or subroutines.

The apparatus 10 may be operated in accordance with the method 12 shown in FIG. 2 to assign the identifier 22 to the digital image 14 and to allow the digital image 14 to be accessed over the network 16. In the first step 30 of method 12, the digital image 14 is acquired. To acquire the digital image 14, the user 20 may, for example, use the digital image capture device 18. Alternatively, the digital image 14 may be retrieved from elsewhere on the network 16 (e.g., via email, etc.). Regardless of how the digital image 14 is acquired, the next step 32 comprises the various functional aspects of the invention. More specifically, in step 32, the digital image 14 may be stored (36) so that the digital image 14 is accessible over the network 16. For example, the digital image 14 may be stored within the digital image capture device 18, on the network device 19, on the first and/or second server 37 and/or 39 of network site 28, elsewhere on the network 16, a combination thereof, etc. Also during the functional phase 32 of method 12, the digital image 14 may be assigned (38) the identifier 22 that may be used to access the digital image 14 over the network 16. More specifically, the identifier 22 may provide the location or site on the network 16 from which the digital image 14 may be accessed (e.g., found, retrieved, edited, displayed, printed, shared, tracked, etc.). The identifier 22 may be assigned to the digital image 14 after the digital image 14 has been stored, while the digital image 14 is being stored, and even as early as before the digital image 14 is stored. After the identifier 22 is assigned, however, the identifier 22 may be stored (40) in a computer readable file, such as a text file based on a markup language such as HTML, XML, or SGML. As will be explained in greater detail below, various other functions (41) may also occur during the functional phase 32 of method 12.

Assuming now that a user (e.g., user 20, third-party user 24, etc.) wishes to access the digital image 14, the identifier 22 assigned to the digital image 14 may be used at step 42 to locate the digital image 14 on the network 16. Once located, the digital image 14 may be transmitted over the network 16 to the requesting party at step 44. In one embodiment, steps 42 and 44 may be accomplished when a user enters the identifier 22 into an address field of a web browser, and the web browser locates and retrieves the digital image 14. In another embodiment, the identifier 22 may be provided as a hyperlink (e.g., text hyperlink, etc.) that may be activated when the hyperlink is clicked (e.g., with a mouse, etc.). Activating the hyperlink may then result in the digital image 14 being located and then retrieved over the network 16.

It is understood that the method 12 illustrated in FIG. 2 is merely exemplary of the invention and is not intended to limit the scope thereof. In other embodiments, additional steps may be included in method 12. For example, various other functions (41) may occur during the functional phase 32 of method 12 with such functions being performed automatically, manually, or a combination thereof based on the configuration of the apparatus 10.

The method 12 may also comprise the user 20 providing information, such as a domain name, user IDs, passwords, restrictions, etc. For example, the method 12 may further comprise allow a user to select at least a portion of the identifier 22. In one embodiment, the method 12 includes the additional steps of selecting a domain name, registering the domain name, and then converting the domain name to an IP address. In such an embodiment, at least a portion of the identifier 22 comprises the IP address.

As another example, the user 20 may be able select the level of security that will be used for the digital images (e.g., to select whether access to the digital image 14 will be password-protected, etc.). In one embodiment, the method 12 may include the additional step of preventing unauthorized access to the functional component 26 and/or the digital images assigned identifiers therewith. For example, access to the digital image 14 may be password-protected such that a user may first have to enter an appropriate username and password before accessing the digital image 14. Similarly, a user may first be required to enter an appropriate username and password before a digital image will be assigned an identifier by the functional component 26.

The method 12 may further include the user 20 providing functional settings. For example, the user 20 may be able to provide one or more email addresses to which the identifiers after being assigned are automatically forwarded.

As mentioned earlier, the functional component 26 may reside elsewhere on the network 16 instead of within the digital image capture device 18. In such an embodiment, the method 12 may further comprise transferring the digital image 14 from the digital image capture device 18 to the functional component 26. In addition, the method 12 may also comprise the additional step of allowing the user 18 to discard a digital image after it has been assigned an identifier. For example, the user 20 may be able to access the network 16 and delete the digital image 14 from the device upon which it was stored.

Another step that may be included in method 12 is referencing the digital image 14 over the network 16 in an object-oriented manner. In other words, the method 12 may further include treating the digital image 14 as an object instead of just treating it as data. Such an object-oriented approach may allow for the support of “methods” which may be used in conjunction with the digital image 14 (e.g., resizing the digital image 14, printing the digital image 14, rotating the digital image 14, etc.) and the support of “properties” of the digital image 14 (e.g., file size, capture date, last access, etc.). For example, the method 12 may comprise specifying a format (e.g., black and white, low resolution, original version, latest version, thumbnail image, file format, etc.) for the digital image 14 and formatting the digital image 14 in that specified format before the digital image 14 is provided to a user. To specify the format, the method 12 may further include the step of allowing a user to specify the format for the digital image 14 and/or the step of adding an extension to the identifier 22.

Tracking the digital image 14 may also be included in the method 12. For example, the method 12 may further comprise maintaining a record that contains access information related to the digital image 14 such as information on the number of times the digital image 14 has been accessed, on the identities of the users who have accessed the digital image 14, on the changes made to the digital image 14, etc. Assuming that such a record is maintained, the method 12 may then further include accessing the record to obtain access information on the digital image 14 (e.g., whether a particular individual has viewed the digital image 14, etc.).

A second embodiment of the apparatus 110 is shown in the high-level diagram FIG. 3. In this alternative embodiment 110, the digital image capture device 118 may be operatively associated with the network device 119. The network device 119 may in turn be operatively associated with or linked to the network 116 (e.g., Internet, Intranet, WAN, LAN, etc.). The network device 119 may be linked to the network 116 via any suitable means (e.g., modem, T-1, T-3, cable, digital subscriber line (DSL), infrared, BLUETOOTH™, etc.), through yet other devices (e.g., routers, hubs, etc.), other networks (e.g., LAN, WAN, Intranet, etc.), through a combination of networks, etc. The network device 119 may comprise any of a wide range of systems capable of linking to the network 116 that are now known in the art or that may be developed in the future, such as a personal computer, a network server, a kiosk, a handheld device, an Internet site, a dedicated e-enabled appliance, a webTV or Internet television, a web terminal, an Internet appliance (i.e., a device dedicated to email, Internet access, and possibly other limited functions), etc.

In the second embodiment 110, the functional component 126 may reside within the network device 119 instead of residing within the digital image capture device 118, as shown in FIG. 1. Alternatively, the functional component 126 may reside elsewhere on the network 116 (e.g., network site 124, etc.), may reside within the digital image capture device 118, may reside in a combination thereof, etc. However, if the functional component 126 does not reside within the digital image capture device 118, the apparatus 110 need not include the digital image capture device 118 since the user 120 may acquire the digital image 114 in any number of other ways. For example, the user 120 may acquire the digital image 114 from a digital image database (not shown) via network 116, from a computer readable storage device 127 of network device 119, from elsewhere on the network 116 (e.g., via email, etc.), etc.

Regardless of how the digital image 114 is acquired, however, the functional component 126 may carry out the various functional aspects of the invention (e.g., assigning an identifier 122 to the digital image 114, storing the digital image 114, storing the identifier 122 in a computer readable file, etc.) in a manner similar to that previously described for the first embodiment 10.

It is to be understood that the computer readable program code described herein can be conventionally programmed using any of a wide range of suitable computer readable programming languages that are now known in the art or that may be developed in the future. It is also to be understood that the computer readable program code described herein can include one or more functions, routines, subfunctions, and subroutines, and need not be combined in a single package but may instead be embodied in separate components. In addition, the computer readable program code may be a stand-alone application, or may be a plug-in module for an existing application and/or operating system. Alternatively, the computer readable program code may be integrated into an application or operating system. In yet another embodiment, the computer readable program code may reside at one or more network devices (not shown), such as an administrator terminal, a server, etc.

What is claimed is:

1. A method, comprising:
acquiring a digital image; and
automatically assigning an identifier to said digital image, said identifier allowing said digital image to be accessed over a network.

2. The method of claim 1, wherein acquiring a digital image comprises using a digital image capture device to capture said digital image.

3. The method of claim 2, wherein said digital image capture device automatically assigns said identifier to said digital image.

4. The method of claim 2, wherein at least a portion of said identifier is based on said digital image capture device.

5. The method of claim 2, further comprising using said identifier to access said digital image at said digital image capture device over said network.

6. The method of claim 2, further comprising transferring said digital image from said digital image capture device to a network device.

7. The method of claim 6, wherein said network device automatically assigns said identifier to said digital image.

8. The method of claim 6, further comprising using said identifier to access said digital image at said network device over said network.

9. The method of claim 1, wherein said identifier comprises a permanent unique uniform resource locator.

10. The method of claim 1, wherein automatically assigning said identifier to said digital image comprises using Internet Protocol version 6 or a later version thereof.

11. The method of claim 1, further comprising storing said identifier in a computer readable file.

12. The method of claim 11, wherein said computer readable file is based on a markup language.

13. The method of claim 1, further comprising referencing said digital image in an object-oriented manner over said network.

14. The method of claim 1, further comprising:
specifying a format for said digital image; and
formatting said digital image so that said digital image is in said format when said digital image is accessed over said network.

15. The method of claim 14, further comprising allowing a user to specify said format.

16. The method of claim 14, wherein specifying a format for said digital comprises adding an extension to said identifier.

17. The method of claim 1, further comprising:
selecting a domain name; and
converting said domain name to an Internet Protocol address, at least a portion of said identifier comprising said Internet Protocol address.

18. The method of claim 1, wherein at least a portion of said identifier is based on information provided by a user.

19. The method of claim 1, further comprising tracking said digital image.

20. The method of claim 1, further comprising sharing said identifier to share said digital image.

21. Apparatus, comprising:
one or more computer readable storage media;
computer readable program code stored on said one or more computer readable storage media, comprising:
program code for acquiring a digital image; and
program code for automatically assigning an identifier to said digital image, said identifier allowing said digital image to be accessed over a network.

22. The apparatus of claim 21, wherein said computer readable program code further comprises program code for referencing said digital image in an object-oriented manner over said network.

23. The apparatus of claim 21, wherein said program code for automatically assigning an identifier to said digital image comprises program code for assigning a permanent unique uniform resource locator to said digital image.

24. The apparatus of claim 21, wherein said program code for automatically assigning an identifier to said digital image comprises program code for using Internet Protocol version 6.

25. The apparatus of claim 21, wherein said computer readable program code further comprises program code for using said identifier to access said digital image over said network.

26. The apparatus of claim 21, wherein said computer readable program code further comprises:
program code for specifying a format for said digital image; and
program code for formatting said digital image so that said digital image is in said format when said digital image is accessed over said network.

27. The apparatus of claim 26, wherein said program code for specifying a format for said digital image comprises program code for allowing a user to specify said format.

28. The apparatus of claim 21, wherein at least a portion of said identifier is based on information provided by a user.

29. The apparatus of claim 21, wherein at least a portion of said identifier is based on a digital image capture device that captured said digital image.

30. The apparatus of claim 21, wherein said computer readable program code further comprises program code for tracking said digital image.

31. Apparatus, comprising:
first means for acquiring a digital image; and
second means for automatically assigning to said digital image third means for allowing said digital image to be accessed over a network; said third means being permanent and unique.

32. A method, comprising:
acquiring a digital image with a digital image capture device;
automatically assigning an identifier to said digital image, said identifier allowing said digital image to be accessed over a network; and
wherein said digital image capture device automatically assigns said identifier to said digital image.

33. A method, comprising:
acquiring a digital image; and
automatically assigning a permanent unique identifier to said digital image, said permanent unique identifier allowing said digital image to be accessed over a network.
